(19) United States
(12) Patent Application Publication
(10) Pub. No.: US 2002/0128827 A1
(43) Pub. Date: Sep. 12, 2002

(54) Perceptual phonetic feature speech recognition system and method

(76) Inventors: Linkai Bu, Tainan (TW); Tzi-Dar Chiueh, Taipei (TW)

Correspondence Address: BAKER & McKENZIE, 101 West Broadway, 12th Floor, San Diego, CA, 92101, US

(21) Appl. No.: 09/904,327

(22) Filed: Jul. 12, 2001

(30) Foreign Application Priority Data
Jul. 13, 2000 (TW) 89114002

(51) Int. Cl. G10L 19/12

(52) U.S. Cl. 704/222

(57) ABSTRACT

A complete system and method for accurate and robust speech recognition based on the application of three perceptual processing techniques to the speech Fourier spectrum to achieve a robust perceptual spectrum and the accurate recognition of that perceptual spectrum by projecting the perceptual spectrum onto a set of reference vowel spectrum vectors for input to a speech recognizer. The invention comprises a perceptual speech processor for preceptually processing the input speech spectrum vector to generate a perceptual spectrum, a storage device for storing a plurality of reference spectrum vectors and a phonetic feature mapper, coupled to said perceptual speech processor and to said storage device, for mapping said perceptual spectrum onto said plurality of reference spectrum vectors.

### FIELD OF THE INVENTION

This invention relates generally to automatic speech recognition systems and more specifically to a perceptual speech processing and stationary vowel-based phonetic feature regime for achieving accurate and robust automatic speech recognition.

### BACKGROUND OF THE INVENTION

Modern automatic speech recognition (ASR) systems have been in development for over 30 years and have made considerable progress. However, there remain two significant problems: a robustness problem typically related to adverse conditions in the speaking environment, such as background noise, speech distortion, and each individual's articulation effects, and an accuracy problem related to misrecognition of input speech. Addressing these problems often entail prohibitively high costs of hardware and space and thus are often not practicable.

As for the robustness problem, there have been numerous attempts to extract noise, improve signal-to-noise, and increase signal gain utilizing electronic and mechanical means, but such systems have suffered from computational complexity (e.g., the noise-added composite model spectrum) and detector placement inflexibility (e.g., noise-canceling microphones). In contrast to purely machine-oriented noise perception, speech perception by humans is relatively robust, achieving high recognition accuracy in adverse environments. For example, for an input SNR below 20 dB, the recognition accuracy of conventional ASR systems is significantly degraded whereas human beings easily recognize speech for signal quality as low as 0 dB SNR. Signal distortion, while annoying, seldom causes severe speech misrecognition by humans (unless the amplitude of the signal itself is too low), and individual speaker's articulation characteristics (at least for native speakers) do not generally cause significant perception problems. Thus, there have been attempts to develop speech recognition systems to mimic human speech perception being of essentially of two types. The first models the functionality of a human's auditory system (for example, the basila membrane and development of electronic cochlea), but the system is complicated by numerous feedback paths from the neural system and unknown interactions among auditory nuclei, making such attempts theoretically sound but practically limited. The second attempt utilizes artificial neural networks (ANN) to extract speech features, process dynamic nonlinear speech signals, or combine with statistical recognizers. But ANN systems have the disadvantage of heavy computation requirements making large vocabulary systems impractical.

All ASRs require the use of a spectral analysis model to parameterize the sound signal so that comparisons with reference spectral signals can be made for speech recognition. Linear predictive coding (LPC) performs spectral analysis on speech frames with a so-called all-pole modeling constraint. That is a spectral representation typically given by Xₙ(eⁱ) is constrained to be of the form /A(eⁱ), where A(eⁱ) is a p^{th} order polynomial with z-transform given by

A(z)=1+a₁z⁻¹+a₂z⁻²+ . . . +aₚz^{-p}

The output of the LPC spectral analysis block is a vector of coefficients (LPC parameters) that parametrically specify the spectrum of an all-pole model that best matches the signal spectrum over the period of time of the speech sample frame. Conventional speech recognition systems typically utilize LPC with an all-pole modeling constraint. However, the pole position in an all-pole spectrum typically is affected through the appearance of noise in the valley sections which, if significant, can significantly degrade the signal.

The Mandarin Chinese language embodies tens of thousands of individual characters each pronounced as a monosyllable, thereby providing a unique basis for ASR systems. However, Mandarin (and indeed the other dialects of Chinese) is a tonal language with each word syllable being uttered as one of four lexical tones or one natural tone. There are 408 base syllables and with tonal variation considered, a total of 1345 different tonal syllables. Thus, the number of unique characters is about ten times the number of pronunciations, engendering numerous homonyms which can only be resolved based on speech context. Each of the base syllables comprises a consonant (“INITIAL”) phoneme (21 in all) and a vowel (“FINAL”) phoneme (37 in all). Conventional ASR systems first detect the consonant phoneme, vowel phoneme and tone using different processing techniques. Then, to enhance recognition accuracy, a set of syllable candidates of higher probability is selected, and the candidates are checked against context for final selection. It is known in the art that most speech recognition systems rely primarily on vowel recognition as vowels have been found to be more distinct than consonants. Thus accurate vowel recognition is paramount to accurate speech recognition.

### SUMMARY OF THE INVENTION

The present invention is a complete system and method for accurate and robust speech recognition based on the application of three perceptual processing techniques to the speech Fourier spectrum to achieve a robust perceptual spectrum and the accurate recognition of that perceptual spectrum by projecting the perceptual spectrum onto a set of reference vowel spectrum vectors for input to a speech recognizer. The invention comprises a perceptual speech processor for preceptually processing the input speech spectrum vector to generate a perceptual spectrum, a storage device for storing a plurality of reference spectrum vectors and a phonetic feature mapper, coupled to said perceptual speech processor and to said storage device, for mapping said perceptual spectrum onto said plurality of reference spectrum vectors.

### BRIEF DESCRIPTION OF THE DRAWINGS

FIG. 1 is a block diagram showing each step and component of the speech recognition system according to the present invention.

FIG. 2 is a time domain graph illustrating a mask tone and a masker generated by the masking tone.

FIG. 3 is a frequency domain graph of minimum audible field (MAF) and equal loudness curves.

FIG. 4 is a graph showing the relationship between frequency scale and mel-scale.

FIG. 5 is a flowchart showing the sequence and processing of perceptual characteristics to produce a perceptual spectrum according to the present invention.

FIG. 6(a) is the Fourier spectrum of the Mandarin vowel “i”, (b) shows the result of the masking effect, (c) shows the result of MAF processing, and (d) shows the result of mel-scale resampling according to the present invention.

FIG. 7 is a graph of an experiment measuring recognition rate against signal-to-noise (SNR) according to the present invention.

FIG. 8 illustrates an embodiment of a masking Winner-Take-All circuit 800 according to the present invention.

FIG. 9 is a graph illustrating piecewise linear resistors PWLₙ utilized to produce a current vs. differential voltage according to the present invention.

FIG. 10 is a graph of the current output of a masker according to the present invention.

FIG. 11 is a graph illustrating envelope extraction by plotting node voltages corresponding to different PWLs according to the present invention

FIG. 12 is a conceptual schematic diagram of a single masking WTA cell according to an embodiment of the present invention.

FIG. 13 is a spectrogram of a stationary vowel “i” and a non-stationary vowel “ai” illustrating the differences according to the present invention.

FIG. 14 is a spectrogram of, and the mel-scale frequency representation of, the nonstationary vowel “ai” according to the present invention.

FIG. 15(a) shows projection similarity as proportional to the projection of an input vector x along the direction of a reference vector c(k) with predetermined weighting; and 15(b) shows a case of spectrally similar reference vowels, “i” and “iu”.

FIG. 16(a) is a vector diagram depicting projection similarity and

FIGS. 16(b) and 16(c) depict relative projection similarity according to the present invention.

FIG. 17 is a plot of the phonetic feature profile of the Mandarin vowel “ai” according to the present invention.

FIG. 18(a) shows the projection similarity to a⁽⁸⁾ (the vertical axis) and to a⁽⁶⁾ (the horizontal axis) of the vowel “i” (dark dots) and the vowel “iu” (light dots).

FIG. 18(b) shows a comparison of the discernibility of projection similarity (without relative projection similarity) and the present invention's phonetic feature scheme for the reference spectra of the same vowels

FIG. 19 is a graph of the “iu” phonetic feature versus the “i” phonetic feature with as a parameter according to the present invention.

FIG. 20 is a graph of Recognition Rate versus SNR for an experiment adding white noise to input speech signals not in any training set according to the present invention.

FIG. 21 is a graph of the Recognition Rate versus SNR results of an experiment of three noisy speech tests using nine Mandarin vowels and projection similarity as inputs according to the present invention.

FIG. 22 is a graph of Outside Recognition Rate (%) (using different speakers) versus Inside Recognition Rate (%) (using a single speaker) according to the present invention.

FIG. 23 is a graph of Noisy Speech Recognition Rate (%) (environmental noise) versus Inside Recognition Rate (%) (where there are more ideal listening conditions) according to the present invention.

### DETAILED DESCRIPTION OF THE INVENTION

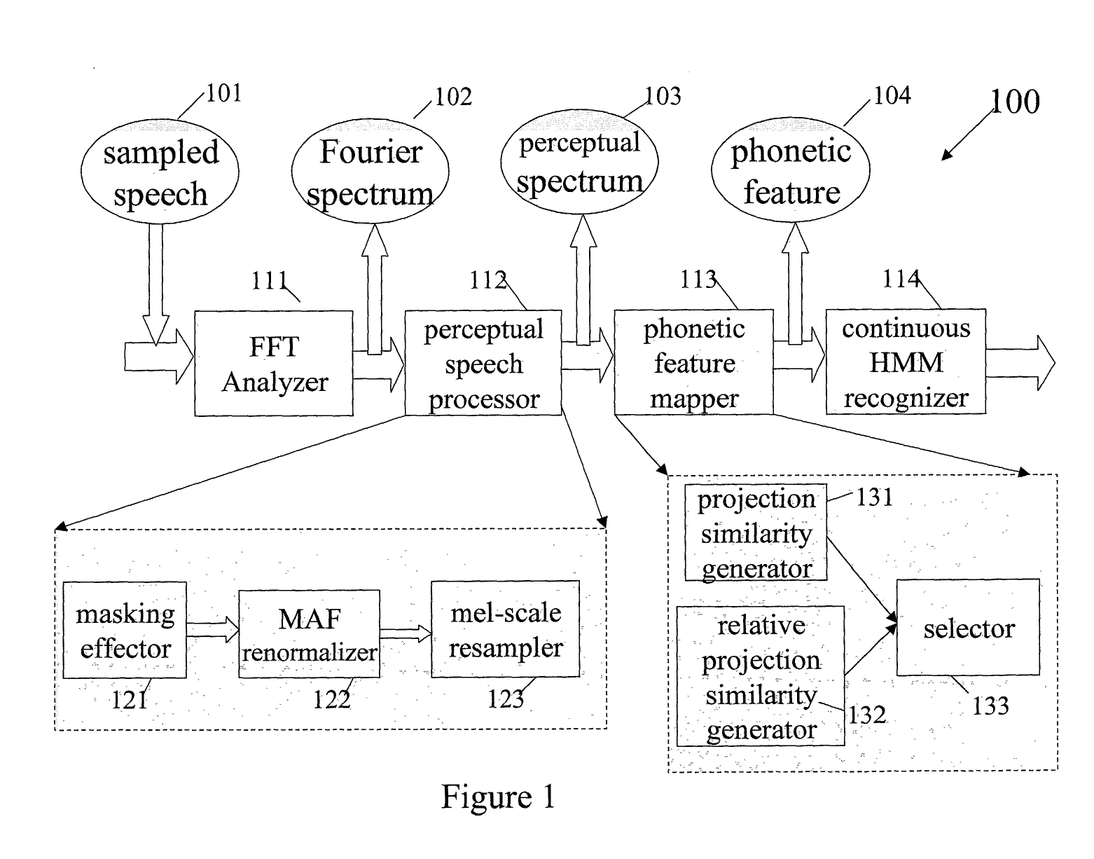

This invention's fundamental concept derives from the psychology and physiology of human speech and perception. Specifically, the human perception of noises and sounds and how they are differentiated is at least partially a function of the psychological perception by a human of human speech. The present invention utilizes a perceptual spectrum for the psychological aspect and a phonetic feature regime for the physiological aspect of speech recognition. These components are combined into an automatic speech recognition system achieving both robustness and accuracy. FIG. 1 is a block diagram of the preferred embodiment of the present invention showing each step and component of the speech recognition system. Sampled speech 101 is input into a Fast Fourier Transform (FFT) analyzer 111 which outputs a Fourier spectrum of the sampled speech which is then inputted to perceptual speech processor 112 which outputs a perceptual spectrum 103 which is then inputted into phonetic feature mapper 113 which outputs a phonetic feature which is then inputted into continuous HMM recognizer 114. Perceptual speech processor comprises masking effector 121, maximum audible field (MAF) curver 122, and mel-scale resampler 123. Phonetic feature mapper 113 comprises projection similarity generator 131 and relative projection similarity generator 132 which in turn inputs into selector 133 which chooses between the outputs of each responsive to the spectral character of the input spectrum vector (whether it has high projection similarity with more than one reference spectrum vector, as described more fully below). Automatic speech recognition systems sample points of a speech spectrum for a discrete Fourier transform calculation of the amplitudes of the component waves of the speech signal. The parameterization of speech waveforms generated by a microphone is based upon the fact that any wave can be represented by a combination of simple sine and cosine waves; the combination of waves being given most elegantly by the Inverse Fourier Transform:

g(t)=∫_{-∞}^{∞}G(t)e^{i2πft}df

where the Fourier Coefficients are given by the Fourier Transform:

G(f)=∫_{-∞}^{∞}g(t)e^{-i2πft}dt

which gives the relative strengths of the components (amplitudes) of the wave at a frequency f, the spectrum of the wave in frequency space. Since a vector also has components which can be represented by sine and cosine functions, a speech signal can also be described by a spectrum vector. For actual calculations, the discrete Fourier transform is used:

$$G ( \frac{n}{τ N} ) = {\sum }_{k = 0}^{N - 1} [ τ \cdot g ( k τ ) {ⅇ}^{- i2πk \frac{n}{N}} ]$$

where k is the placing order of each sample value taken, is the interval between values read, and N is the total number of values read (the sample size). Sampled speech 101 is generated by “sampling” the speech waveform by taking a sufficient number of points on the wave spectrum to make a sufficiently precise calculation of amplitudes using the FFT. The Fast Fourier Transform (FFT) analyzer 111 generates the Fourier spectrum 102 of waves by using the discrete Fourier transform and efficiently taking a series of shortcuts based on observations of recurring quantities derived from the circularity of trigonometric functions, which allows one calculation's results to be used for another, thereby reducing the total number of calculations required.

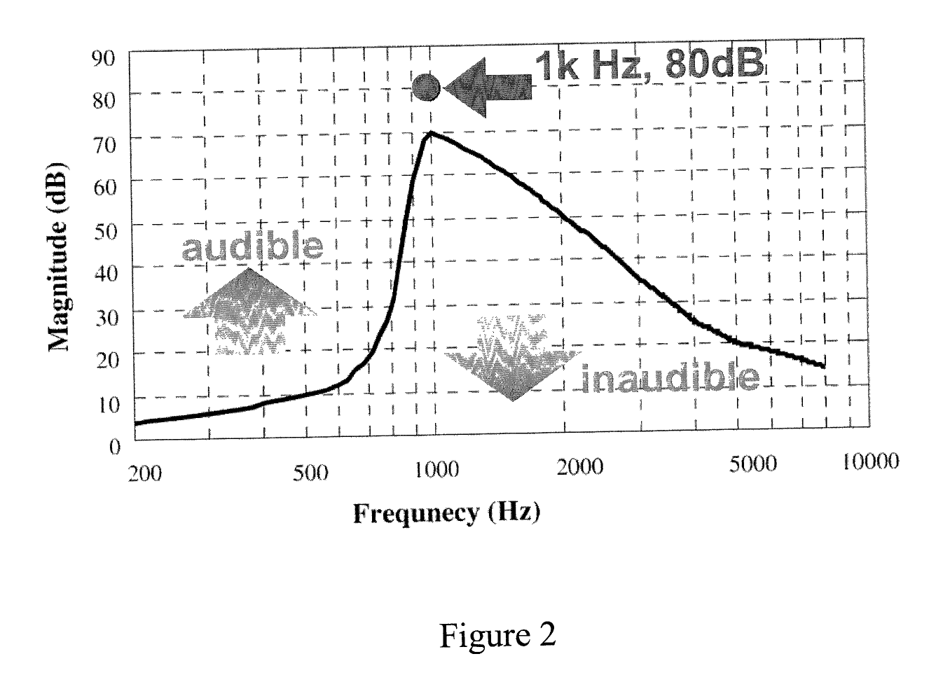

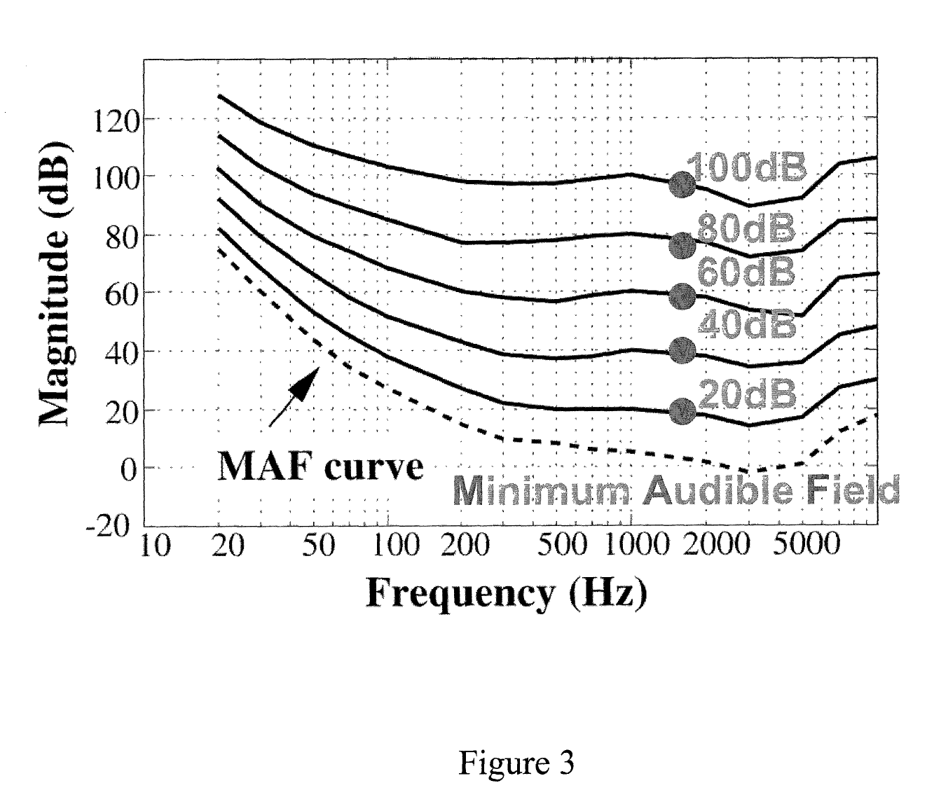

The masking effect utilized in masking effector 121 is the observed phenomenon that certain sounds become inaudible when there are other louder sounds which are both temporally and spectrally proximate. The masking effect can be measured by experiments of humans' subjective response. FIG. 2 is a frequency domain graph showing the magnitude of a mask tone (solid line 201) generated by a 1 kHz, 80 dB pure tone (small circle 200). Any signal below solid line 101 will be inaudible and if its frequency is proximate the mask tone, it moreover will be seriously inhibited, with the inhibition being greater towards the high frequencies. FIG. 3 is a frequency domain graph of minimum audible field (MAF) below which sound signals are too weak to be perceived by humans (the dashed curve 300) and equal loudness curves 301, 302, 303, 304, and 305. To translate objective sound signal magnitude to human subjective loudness, the magnitude of a particular frequency component of the signal must be renormalized to the MAF curve as follows:

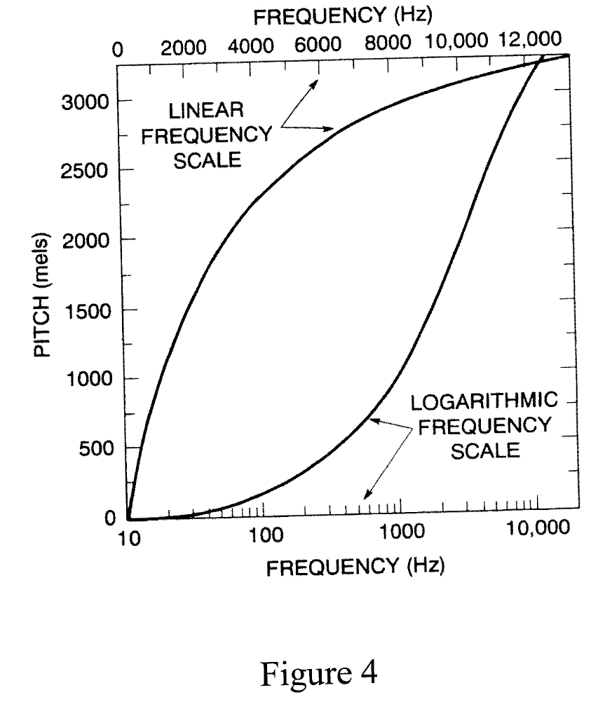

L(in dB)=M(in dB)−MAF

where L and M re the loudness and magnitude of a frequency component of the sound signal respectively, and MAF is the value of MAF at that frequency. In another embodiment of the present invention, the magnitude of a given frequency component is renormalized to all of the equal loudness curves 301, etc. To describe human subjective pitch sensation, the frequency scale is adjusted to a perceptual frequency scale termed the mel-scale. In mel-scale, the low frequency spectral band is more pronounced than the high frequency spectral band. FIG. 4 is a graph showing the relationship between Hertz-(or frequency) scale and mel-scale given by:

mel=2595×log(1+f/700)

where f is the signal frequency.

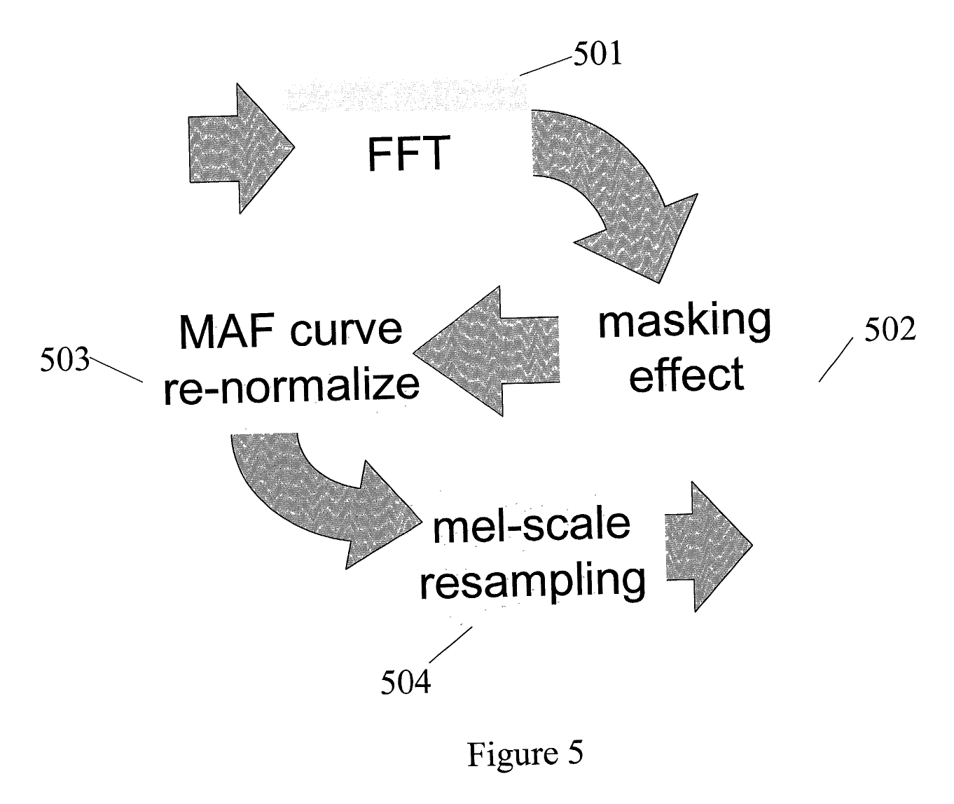

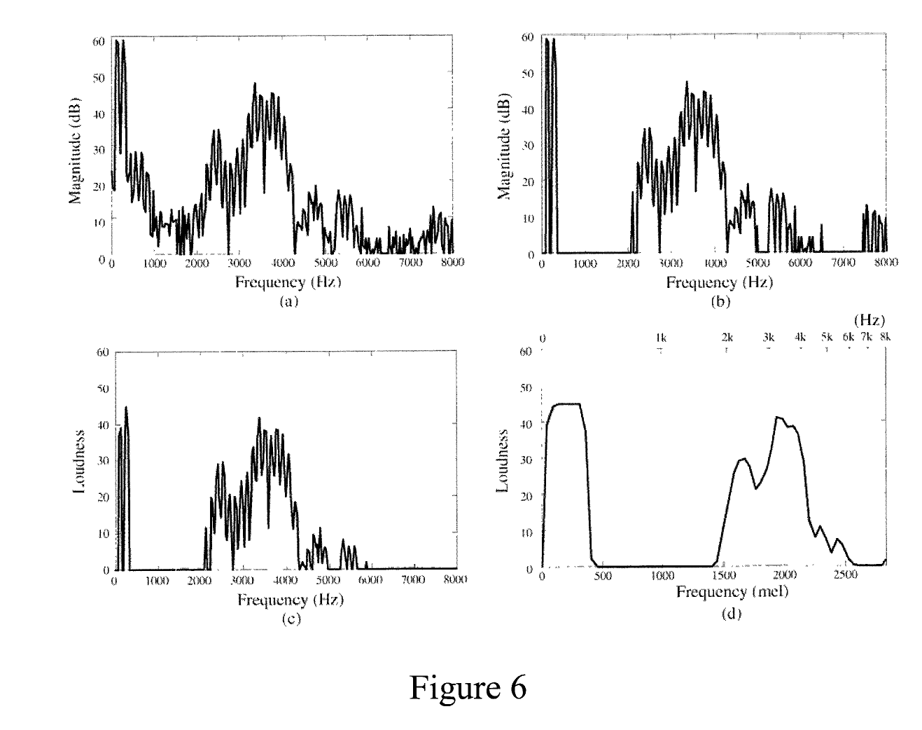

The sequence and processing of the perceptual characteristics described above to produce a perceptual spectrum in a preferred embodiment of the present invention is shown in the flowchart of FIG. 5. Step 501 is the FFT generation inputted into step 502 which removes all the frequency components of the sound signal that are shadowed by louder neighboring sounds according to the final masker in the previous and current frames of the sound signal. Step 503 is the renormalization of the magnitude of each frequency component of the sound signal according to the MAF curve and step 504 is the translation of the frequency components to mel-scale by resampling. This sequence of steps is arranged for computational efficiency and is not necessarily the same sequence as for an auditory pathway. It is understood by those in the art that any order of the steps 501, 502, 503, and 504 are within the contemplation of this invention. The results of steps 501, 502, 503, and 504 are shown in FIG. 6 wherein (a) is the Fourier spectrum of the Mandarin vowel “i”, (b) is the result of step 502 masking effect, (c) is the result of step 503 MAF processing, and (d) is the result of mel-scale resampling. FIG. 6(b) shows that the masking effect eliminates most frequency components between 400 Hz and 2 kHz, greatly reducing the amount of information to be processed and removing significant background noise. FIG. 6(c) shows that low and high frequency components are considerably attenuated and FIG. 6(d) shows a perceptual spectrum of the exemplary vowel “i” according to the preferred embodiment of the present invention. In another embodiment, the low frequency components, where most vowel information is carried, are sampled more finely than for other frequencies. The final perceptual spectrum preserves only a spectral envelope as that alone conveys significant information concerning the shape of the vocal tract. Pitch information is also advantageously removed as it is not essential to vowel recognition. Step 502, the mask effect, is different from the conventional all-pole spectrum model. The all-pole model produces concave smoothed valleys in the spectrum, whereas the present invention generates sharp edges. When the spectrum is contaminated by noise, the pole position in an all-pole spectrum typically is affected through the appearance of noise in the valley sections. In the present invention, most valley noises are removed by the masker, thus achieving cleaner signals.

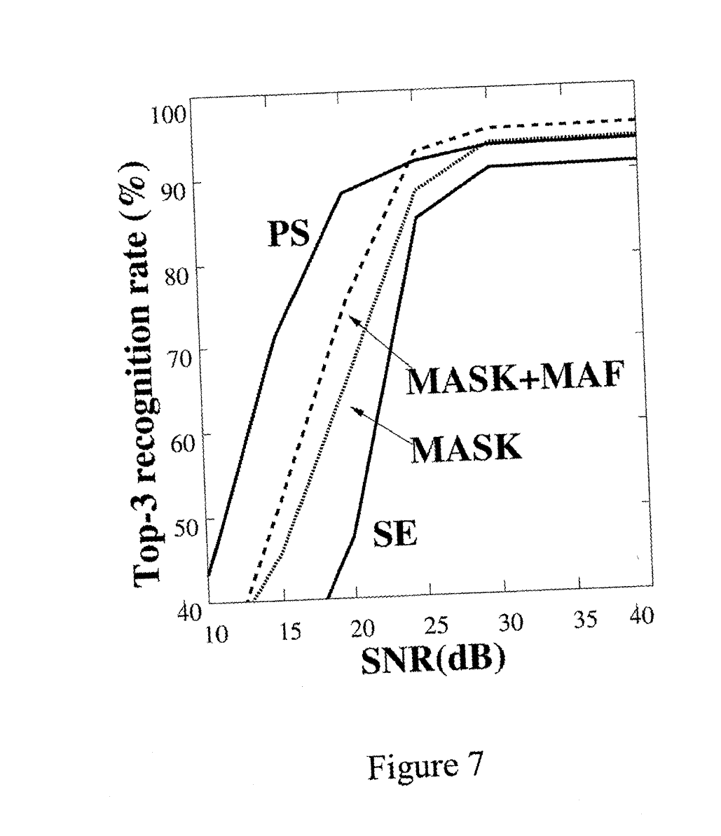

FIG. 7 is a graph of an experiment measuring recognition rate against signal-to-noise (SNR). The perceptual spectrum curve (PS) compared to an FFT Spectrum Envelope curve (SE) results in significantly lower SNR and higher recognition rates. The masking effect (MASK) and MAF renormalization and MASK by itself also significantly enhance recognition rates and reduce noise as compared to SE.

Noise masking is the phenomenon whereby weaker tones become inaudible when there is a temporally and spectrally adjacent louder tone present. It is known that auditory neurons are arranged in order of their respective resonant frequencies (the tonotopic organization), so inhibiting the perception of neighboring frequency components corresponds to the inhibition of lateral auditory neurons. The activity of a neuron depends on the neuron's input, as well as inhibition and excitation from neighbors. Neurons with stronger outputs will inhibit lateral neighbors via synaptic connections. Assuming a neuron i has the strongest input stimuli, neuron i will then inhibit its neighbors most as well as excite itself most. Because other neurons in the area are non-competitive (“muted”) with neuron i, only neuron i generates output. This surviving neuron i is the “winner” in the so-called Winner-Take-All (WTA) neural network which extends, reasonably, only to localized regions as the interactions become weaker for farther-away neurons. A “global” model of the WTA network is an electronic circuit having n neurons each represented by two nMOS transistors, all of which are coupled at a node. When an input stimuli is simulated using an electric current to the transistors in parallel, the voltage level of the node depends on the transistor (neuron) having the highest current input. In equilibrium, a bias current flows through the winner neuron effectively inhibiting the output currents of all the other neurons. By separating the transistors with resistors in series, and biasing each transistor, the circuit can be “localized”.

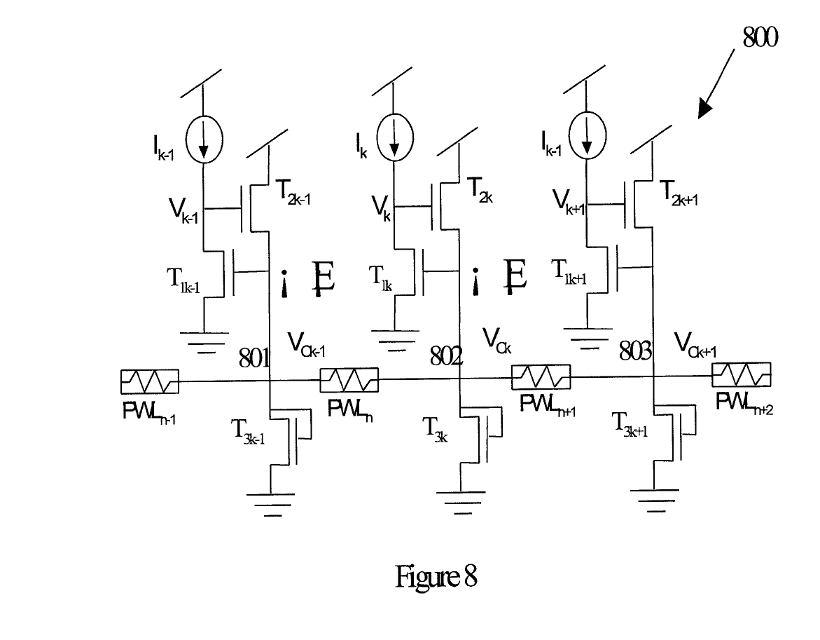

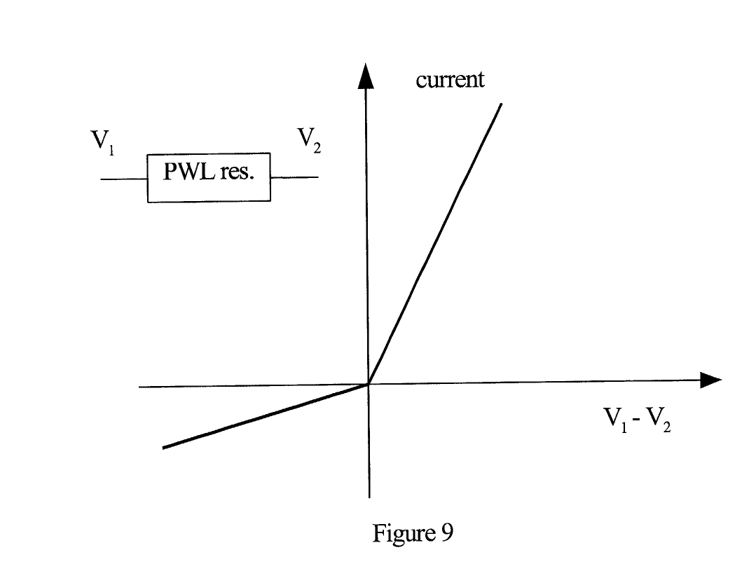

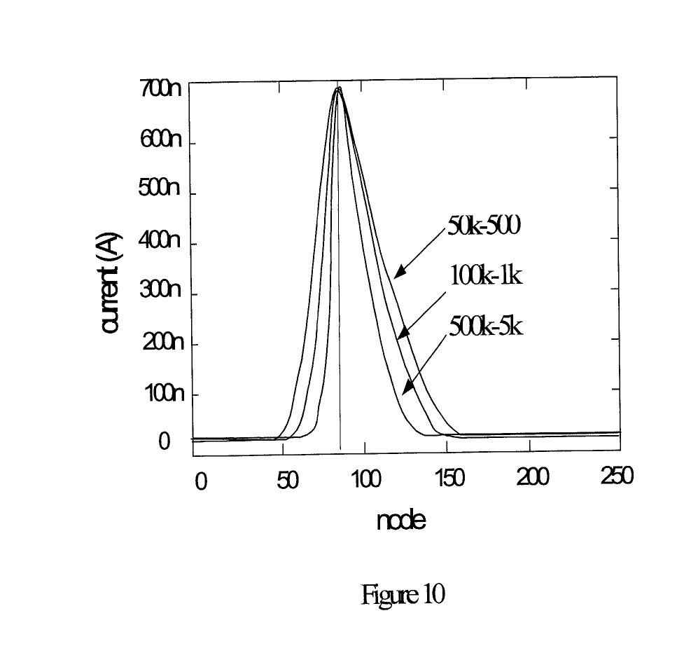

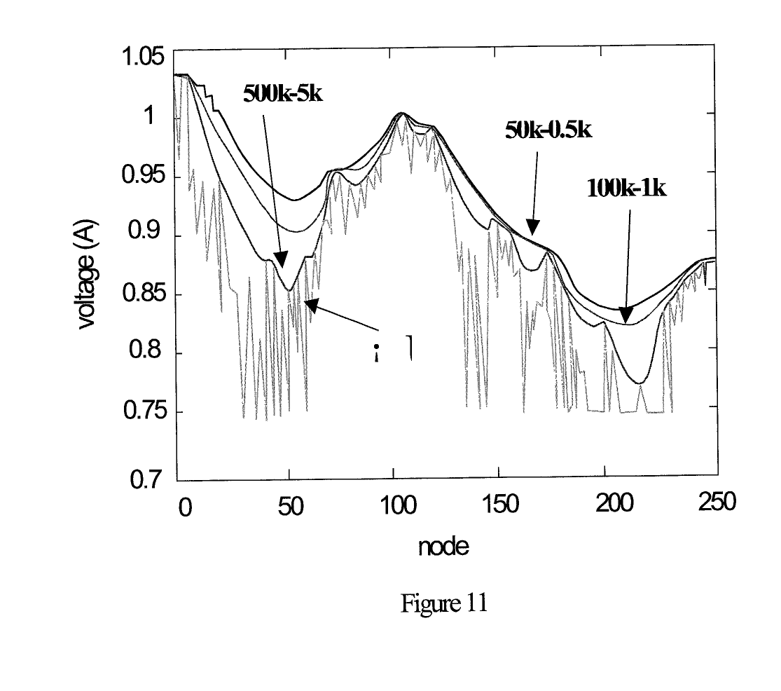

FIG. 8 illustrates an embodiment of a masking Winner-Take-All circuit 800 according to the present invention. Current sources Iₖ input current into nMOS transistor pairs T₁ₖ, T₂ₖ, producing transistor voltages Vₖ, and node voltages V_{Ck}. Piecewise linear resistors PWLₙ are coupled in series between the nodes 801, 802, 803, . . . which are coupled to diode-connected nMOS transistors T₃ₖ. Piecewise linear resistors PWLₙ produce a current vs. differential voltage shown in FIG. 9, and generates the observed asymmetric inhibitory characteristics of the masking effect (see FIG. 1). Experiments conducted utilized a 256 cell (neuron/transistor pair) SPICE simulation. FIG. 10 is a graph of the current output of a masker according to the present invention generated by a simple tone input to neuron number 30 of 700 nA and 100 nA to the other cells, wherein the observed mask effect asymmetry is achieved. Vowel spectrum inputs into the present invention produce winning spectral components (highest output currents) which not only inhibit neighboring spectral components, but also absorb neighbors' bias currents, thus increasing the “winners” own output currents and increasing formant extraction effectiveness. “Formants” are the defining characteristics (peaks in the sound spectrum) and thus the more pronounced, the better the speech recognition. Further, the components are clearly quantized, each being a harmonic of the fundamental frequency. Information for distinguishing different phonemes is carried in the envelope of a speech spectrum. The masking WTA system of the present invention further extracts spectrum envelopes from the inputted speech. Node voltage V_{Ck} in FIG. 8 exhibits a smoothed spectrum envelope of the input current Iₖ. If the neuron in question corresponds to a spectral valley, then the current output of that neuron will be inhibited by its neighboring peaks, but the node voltage will also increase (as mentioned above) so a smooth node voltage corresponding to the envelope of the input spectrum is achieved. FIG. 11 shows the envelope extraction. The solid curves are node voltages corresponding to different PWLs and the dashed curve is where there are no resistances.

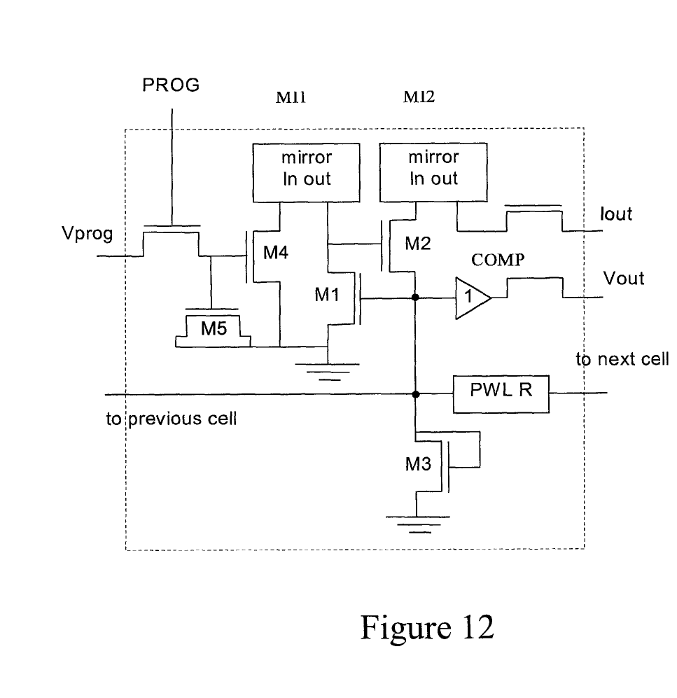

FIG. 12 is a conceptual schematic diagram of a single masking WTA cell according to an embodiment of the present invention. Three nMOS transistors M1, M2, and M3, a PWL R resistor, a voltage buffer, MOS capacitor M5 and two current mirrors MI1 and MI2. In the programming phase, an input voltage is stored at MOS capacitor M5; M4 converts the voltage to current for input through current mirror MI1. In operation, voltage output is buffered by a unity-gain buffer and then coupled to an output bus. Output current is copied by current mirror MI2 and transmitted to a current output bus. Output current is then converted to voltage by a linear grounded resistor PWL R. PWL R has resistance sensitive to current direction changes (FIG. 9), the perceptual masking curve (FIG. 2), and the ratio of the leftward resistance to rightward resistance is as large as 100. The two nMOS transistors M1 and M2 act as passive resistors for the two current flow directions with a comparator COMP switching between M1 and M2 depending on the sign of the voltage drop (the resistances being adjusted by the gate voltages). This embodiment of the present invention was implemented with supporting circuitry (for stability, signal gain, and leakage-avoidance) in a UMCTM 0.5 micron double-poly double-metal CMOS process. The voltage outputs generate the spectrum envelope and the current outputs generate the spectrum formants. Utilizing the masking WTA circuit of the present invention, the formants of the vowel, “ai” are clearly visible in spectrograms even with the addition of noise in the input signal.

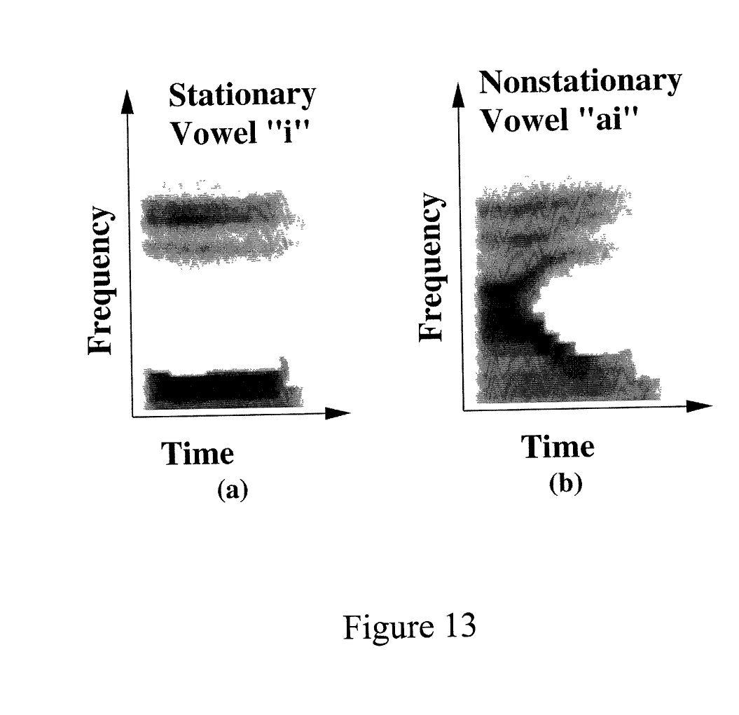

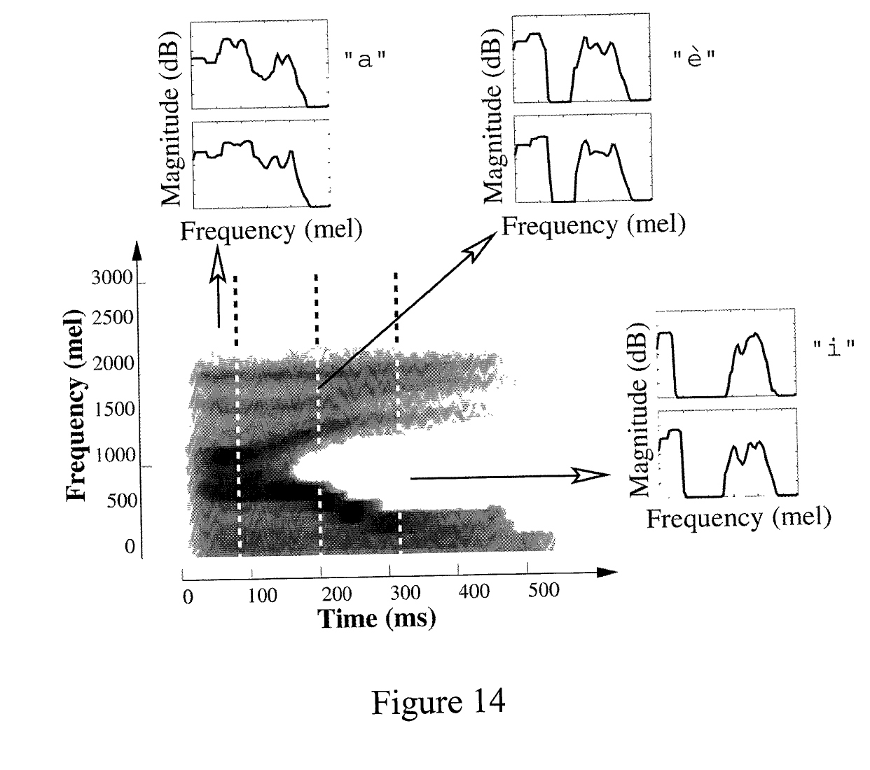

In the preferred embodiment of the masking WTA network of the present invention, an analog parallel processing system is advantageously utilized to integrate with the other components of an ASR system. For example, a band-pass filter bank is coupled to the upstream to provide input to the masking WTA network. Phonetic feature mapper 113 (FIG. 1) comprises projection similarity generator 131 and relative projection similarity generator 132 which feed phonetic feature generator 133 which generates phonetic features for speech recognition extraction according to the preferred embodiment of the present invention. Phonetic feature extraction is based upon the physiology of human speech (as opposed to the perceptual spectrum described above which is based upon psychological aspects of human speech). When humans speak, air is pushed out from the lungs to excite the vocal cord. The vocal tract then shapes the pressure wave according to what sounds are desired to be made. For some vowels, the vocal tract shape remains unchanged throughout the articulation, so the spectral shape is stationary in time. For other vowels, articulation begins with a vocal tract shape, which gradually changes, and then settles down to another shape. For the stationary vowels, spectral shape determines phoneme discrimination and those shapes are used as reference spectra in phonetic feature mapping. Non-stationary vowels, however, typically have two or three reference vowel segments and transitions between these vowels. FIG. 13 is a spectrogram of a stationary vowel “i” and a non-stationary vowel “ai” illustrating the differences. FIG. 14 is a spectrogram of, and the mel-scale frequency representation of, the nonstationary vowel “ai” showing the initial phase having a spectrum similar to vowel “a”, a shift to a spectrum similar to the vowel “e”, and finally settling down to a spectrum similar to the vowel “i”. The preferred embodiment of the present invention utilizes nine stationary vowels to serve as reference vowels to form the basis of all 37 Mandarin vowels. Table 1 shows the 37 Mandarin vowel phonemes and the nine reference phonemes. The spectra of the nine reference vowels are represented by c where i=1, 2, . . . , 9 and each is a 64-dimensional vector (or wave component in an inverse Fourier transform) computed by averaging all frames of a particular reference vowel in a training set.

To reduce the dimensionality of the data fed to the CHMM recognizer 114, in one embodiment of the present invention, phonetic feature mapper 113 generates nine features from a 64-dimensional spectrum vector. Phonetic feature mapper 113 first computes the similarities of an input spectrum to the nine reference spectrum vectors, then computes another set of 72 relative similarities between the input spectrum and 72 pairs of reference spectrum vectors. The final set of nine phonetic features is achieved by combining these similarities. Unlike conventional classification schemes that categorize the input spectrum into one of the reference spectra, the present invention quantitatively gauges the shape of the input spectrum (also the shape of the vocal tract) against the nine reference spectra. The present invention's phonetic feature mapping is a method of feature extraction (or dimensionality reduction) through similarity measures. The preferred embodiment of the present invention utilizes projection-based similarity measures of two types: projection similarity and relative projection similarity.

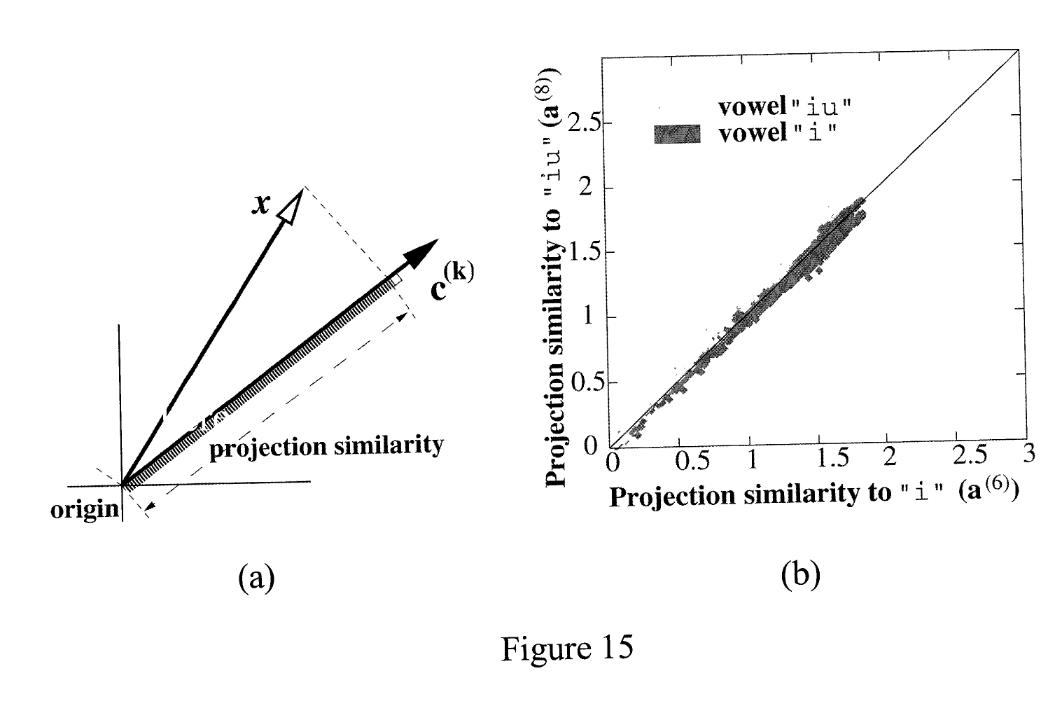

FIG. 15(a) shows projection similarity as proportional to the projection of an input vector x along the direction of a reference vector c(k) with predetermined weighting, given by:

$${a}^{( k )} = \sum {w}_{i}^{( k )} \cdot {x}_{i} \cdot \frac{{c}_{i}^{( k )}}{‖ {c}^{( k )} ‖}$$

where k=1, . . . , 9 and

$${c}^{( k )} = {( \sum }_{i = 1}^{64} {( {c}_{i}^{( k )} )}^{2}$$

and the weighting factor is given by

$${w}_{i}^{( k )} = \frac{{c}_{i}^{( k )} / {σ}_{i}^{( k )}}{{\sum }_{i = 1}^{64} {c}_{i}^{( k )} / {σ}_{i}^{( k )}}$$

where i=1, 2, . . . , 64 and k=1, 2, . . . , 9 and ᵢ^{(k)} is the standard deviation of dimension i in the ensemble corresponding to the k^{th} reference vowel. The ᵢ^{(k)} in the weighting factor wᵢ^{(k)} serves as a constant that makes all dimensions in all nine reference vectors of the same variance. The cᵢ^{(k)} term in the weighting factor emphasizes the spectral components having larger magnitudes. The set of weights that correspond to each reference vector is normalized.

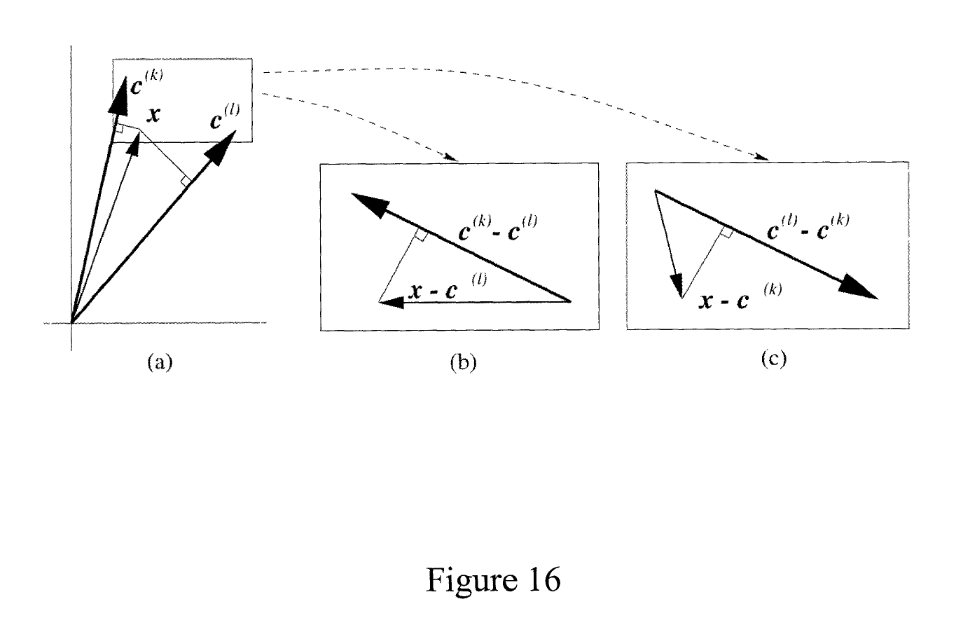

For many cases, the projection similarities described above are sufficient for accurate speech recognition. But FIG. 15(b) shows a case of spectrally similar reference vowels, “i” and “iu”, where the projection similarities of the input vector on those similar reference vowels will all be large and a speech input will be spectrally close to the similar phonemes, thereby requiring more differentiation to achieve accurate speech recognition. “Relative projection similarity” extracts only the critical spectral components, thereby achieving better differentiation. For ease of illustration, FIG. 16 is a vector diagram depicting relative projection similarity for two-dimensional vectors. Of course, all multi-dimensional vectors are within the contemplation of the present invention. An input vector x is close to two similar reference vectors c^{(k)} and c^{(l)}, being somewhat closer to c^{(k)} but the difference in projections is not large, as shown in FIG. 16(a). The difference between c^{(k)} and c^{(l)} given by c^{(k)}−c^{(l)} is critical for the categorization of the input speech vector x. FIGS. 16(b) and 16(c) show that the projection of x−c^{(l)} on c^{(k)}−c^{(l)} is larger than the projection of x−c^{(k)} on c^{(l)}−c^{(k)} and their difference is more pronounced than the difference between the projections of x alone on c^{(k)} and on c^{(l)}. Using this observation, the statistically-weighted projection of the input vector x on c^{(k)} with respect to c^{(l)} is:

$${q}^{( k , 1 )} = {\sum }_{i = 1}^{64} {v}_{i}^{( k , l )} \cdot ( {x}_{i} - {c}_{i}^{( l )} ) \cdot \frac{( {c}_{i}^{( k )} - ( {c}_{i}^{( l )} )}{‖ {c}^{( k )} - {c}^{( l )} ‖}$$

where k, =1, . . . , 9, l k, and

∥c^{(k)}−c^{(l)}∥={square root over (Εᵢ₌₁⁶⁴(cᵢ^{(k)}−cᵢ^{(l)})²)}.

The normalized weighting factor is given by

$${v}_{i}^{( k , l )} = \frac{\vert {c}_{i}^{( k )} - {c}_{i}^{( l )} \vert / \sqrt{{( {σ}_{i}^{( k )} )}^{2} + {( {σ}_{i}^{( l )} )}^{2}}}{{\sum }_{i = 1}^{64} \vert {c}_{i}^{( k )} - {c}_{i}^{( l )} \vert / \sqrt{{( {σ}_{i}^{( k )} )}^{2} + {( {σ}_{i}^{( l )} )}^{2}}}$$

where i=1, . . . , 64; k, l=1, . . . , 9, l k. The weighting factors serve to emphasize those components of the two reference vectors which have large differences as well as to make variances in all dimensions the same. In the cases where q^{(k,l)} is negative, in order to control the dynamic range and maintain the cues for discriminating the input vector, negative q^{(k,l)} is set to a small positive value and positive q^{(k,l)} does not change (unipolar ramping function). The relative projection similarity of x on c^{(k)} with respect to c^{(l)} is defined as

$${r}^{( k , l )} = \frac{{q}^{( k , l )}}{{q}^{( k , l )} + {q}^{( l , k )}}$$

where k,l=1, . . . , 9, l k. Thus there is a total of 8×9=72 relative projection similarities which, together with the nine projection similarities, defines the phonetic features of the preferred embodiment of the present invention.

In one embodiment of the present invention, the integration of the projection similarities and relative projection similarities to recognize speech utilizes a hierarchical classification wherein the projection similarities determine a first coarse classification by selecting candidates having large values for the projection of x on c^{(k)}; that is, large values for a^{(k)}. The candidates are further screened using pairwise relative projection similarities. However, if the first coarse classification is not tuned properly, good candidates may not be selected.

In the preferred embodiment of the present invention, projection similarity and relative projection similarity are integrated by phonetic feature mapping utilizing the scheme: (a) relative projection similarity should be utilized for any two reference vectors having large projection similarities, and (b) otherwise, projection similarity can be used alone. This will not only produce more accurate speech recognition, but also be computationally efficient. The phonetic feature is defined as

$${p}^{( k )} = \frac{1}{λ} {a}^{( k )} + \frac{1}{λ} {\sum }_{l = 1 , l \neq k}^{9} ( {r}^{( k , l )} {p}^{( l )} - {r}^{( l , k )} {p}^{( k )} )$$

where k=1, 2, . . . , 9 and is a scaling factor to control the degree of cross coupling, or lateral inhibition. The solution to the above equation for two reference vectors (for simplicity of illustration) is given by

$$\frac{{p}^{( k )}}{{p}^{( l )}} = \frac{λ {a}^{( k )} + ( {a}^{( k )} + {a}^{( l )} ) {r}^{( k , l )}}{λ {a}^{( l )} + ( {a}^{( k )} + {a}^{( l )} ) {r}^{( l , k )}} .$$

For the case that both a^{(k)} and a^{(l)} are large and have comparable magnitudes, assuming that x is closer to c^{(k)} in the Euclidean norm sense, the distance between x and c^{(k)} is smaller, so r^{(k,l)} is larger than r^{(l,k)}. If is relatively small, then p^{(k)}/p^{(l)} is approximately r^{(k,l)}/r^{(l,k)}, which is determined by r^{(k,l)} and r^{(l,k)}, the relative projection similarities. For the case where only one of a^{(k)} and a^{(l)} is large, assuming that a^{(k)} is large, then r^{(k,l)} and r^{(l,k)} are close to one and zero respectively and

$${p}^{( k )} / {p}^{( l )} \approx \frac{( λ + 1 ) {a}^{( k )} + {a}^{( l )}}{λ {a}^{( l )}} ,$$

which is determined by a^{(k)} and a^{(l)}. For the third and last possible case, where both a^{(k)} and a^{(l)} are small,

p^{(k)}∝λa^{(k)}+(a^{(k)}+a^{(l)})r^{(k,l)}

and

p^{(l)}∝λa^{(l)}+(a^{(k)}+a^{(l)}r^{l,k).}

Since both a^{(k)} and a^{(l)} are small, and r^{(k,l)} and r^{(l,k)} are less than one, thus p^{(k)} and p^{(l)} are also small and negligible. Defining

$${r}^{( k , k )} = λ + {\sum }_{l = 1 , l \neq k}^{9} {r}^{( l , k )}$$

where k=1, 2, . . . , 9, then the equation for p^{(k)} above can be written in matrix form as

$$[ \begin{matrix}- {r}^{( 1 , 1 )} & {r}^{( 1 , 2 )} & {r}^{( 1 , 3 )} & … & {r}^{( 1 , 9 )} \\ {r}^{( 2 , 1 )} & - {r}^{( 2 , 2 )} & {r}^{( 2 , 3 )} & … & {r}^{( 2 , 9 )} \\ {r}^{( 3 , 1 )} & {r}^{( 3 , 2 )} & - {r}^{( 3 , 3 )} & … & {r}^{( 3 , 9 )} \\ ⋮ & ⋮ & ⋮ & ⋰ & ⋮ \\ {r}^{( 9 , 1 )} & {r}^{( 9 , 2 )} & {r}^{( 9 , 3 )} & … & - {r}^{( 9 , 9 )}\end{matrix} ] [ \begin{matrix}{p}^{( 1 )} \\ {p}^{( 2 )} \\ {p}^{( 3 )} \\ ⋮ \\ {p}^{( 9 )}\end{matrix} ] = [ \begin{matrix}- {a}^{( 1 )} \\ - {a}^{( 2 )} \\ - {a}^{( 3 )} \\ ⋮ \\ - {a}^{( 9 )}\end{matrix} ]$$

Phonetic features p^{(k)} for k=1, 2, . . . , 9 is solved by multiplying the inverse of the matrix above on both sides.

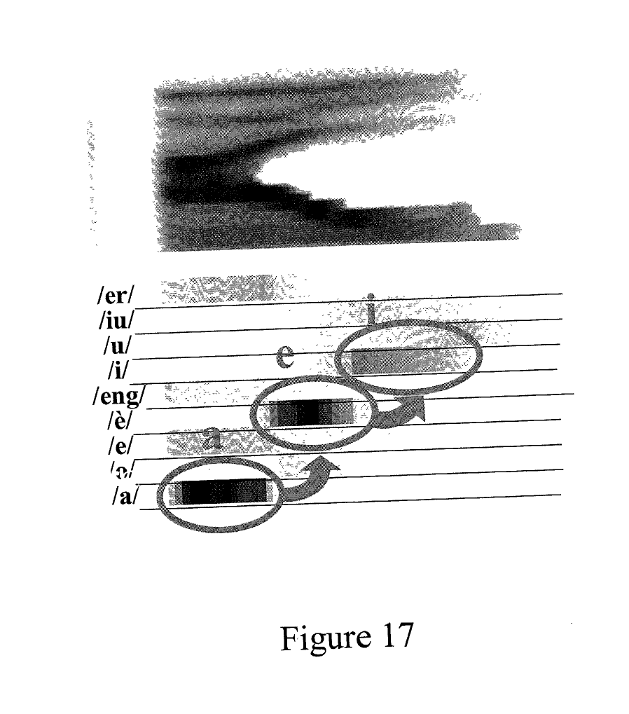

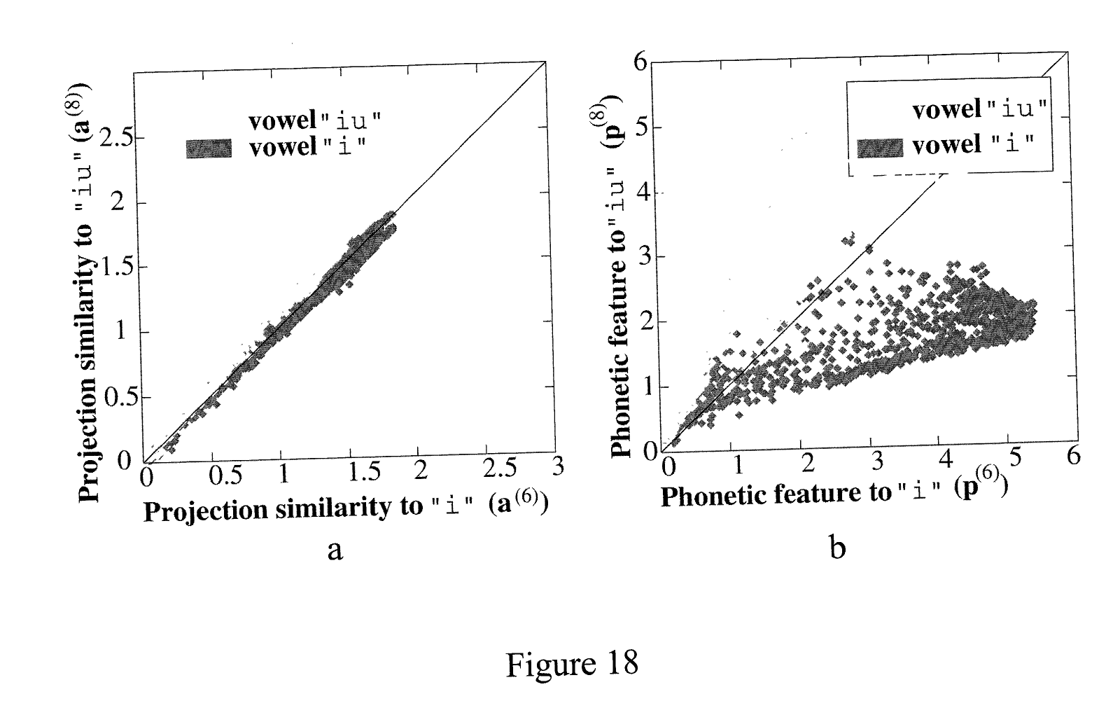

FIG. 17 is a plot of the phonetic feature profile of the Mandarin vowel “ai”; the largest phonetic feature in the beginning is “a”, then a transition to the vowel “e”, and finally “i” becomes the largest phonetic feature. After 450 ms, the phonetic feature “u” becomes visible, albeit relatively short and not conspicuous. The present invention through break-up into basic nine vowels achieves a significant discernibility. By utilizing relative projection similarities to enhance discernibility among similar reference vowels, even greater accuracy speech recognition is achieved. FIG. 18(a) shows the projection similarity to a⁽⁸⁾ (“iu”, the vertical axis) and to a⁽⁶⁾ the horizontal axis) of the vowel “i” (dark dots) and the vowel “iu” (light dots). For projection similarity alone, the discernibility is not great as the different vowels are very close together as shown in FIG. 18(a). However, when the phonetic feature scheme of the present invention is utilized for “i” (p⁽⁶⁾, dark shading) and “iu” (p⁽⁸⁾, light shading), the discernibility is greatly enhanced as seen from the distinct separation of the vowels shown in FIG. 18(b).

Humans perceive speech through several hierarchical partial recognitions. The present invention encompasses partial recognition because, as described immediately above, a vowel is broken up into segments of the nine reference vowels. Further, when listening, humans ignore much irrelevant information. The nine reference vowels of the present invention serve to discard much irrelevant information. Thus, the present invention embodies characteristics of human speech perception to achieve greater speech recognition.

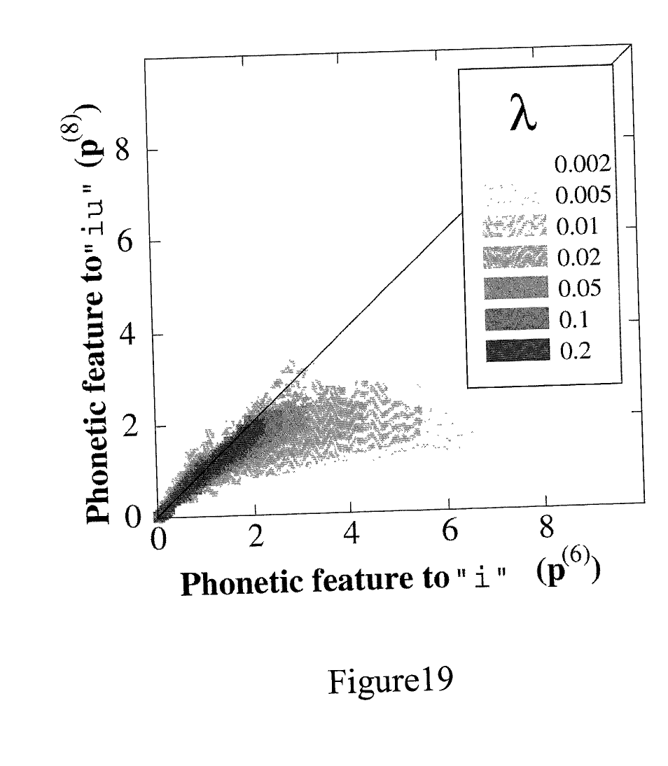

The discernibility of a phonetic feature p^{(k)} in the present invention is controlled by the value given to the scaling factor. As seen in the equation for p^{(k)} above, if is large, the sum of the relative projection similarities r^{(k,l)} is overwhelmed by. FIG. 19 is a graph of the “iu” phonetic feature (p⁽⁸⁾) versus the “i” phonetic feature (p⁽⁶⁾) with as a parameter having larger value with increasing grey scale. Smaller values of scatter the distribution away from the diagonal (which represents non-discernibility), making the two vowels more discernible thereby improving recognition accuracy. However, a too small value for will result in a dispersion that is difficult to model by a multi-dimensional Gaussian function in the continuous HMM (CHMM) recognizer 114 (FIG. 1), resulting in poor recognition accuracy. Thus the present invention advantageously utilizes the value of the scaling factor to optimize discernibility while limiting dispersion.

Continuous Hidden Markov Model recognizer 114 (FIG. 1) utilizes a statistical method of characterizing the spectral properties of the frames of a speech pattern with the assumption that the speech signal can be characterized as a parametric random process and that the parameters of the stochastic process can be determined in a precise manner. An observable Markov model is one in which each state of being corresponds to a deterministically observable event (for example, whether it is raining or sunny), and the output of the model is the set of states at each instant of time (e.g., the days when it is raining) where each state corresponds to an observable event. A hidden Markov model, on the other hand, is a doubly-embedded stochastic process (e.g., tossing more than one coin behind a curtain) with an underlying stochastic process that is not directly observable (hidden behind the curtain), but can be observed only through another set of stochastic processes (coin-tossing) that produce the sequence of observations. Thus, for discrete symbol observations, an HMM is characterized by (a) the number of states in the model, (b) the number of distinct observation symbols per state (e.g., alphabet size), (c) the state-transition probability distribution, (d) the observation symbol probability distribution, and (e) the initial state distribution. The present invention utilizes an isolated word recognizer for a system of V isolated words to be recognized (each word is modeled by a distinct HMM), having a training set of K utterances of each of the words (spoken by one or more talkers), where each utterance constitutes an observation sequence of some representation of the characteristics of the word. For each word v in the vocabulary, the HMM parameters for (c), (d), and (e) above must be estimated to optimize the match to a training set of values for the v^{th} word. The present invention recognizes each unknown word by measurement of the observation sequence via the perceptual spectrum and phonetic feature analysis of the speech. This is followed by a probability calculation of model likelihoods for all possible models, and finally selection of the word with highest model likelihood. The probability computation is typically performed using the maximum likelihood path (Viterbi algorithm). For a detailed description of HMM, refer to Rabiner & Juang, Fundamentals of Speech Recognition, pp 321-389, Prentice-Hall Signal Processing Series, 1993.

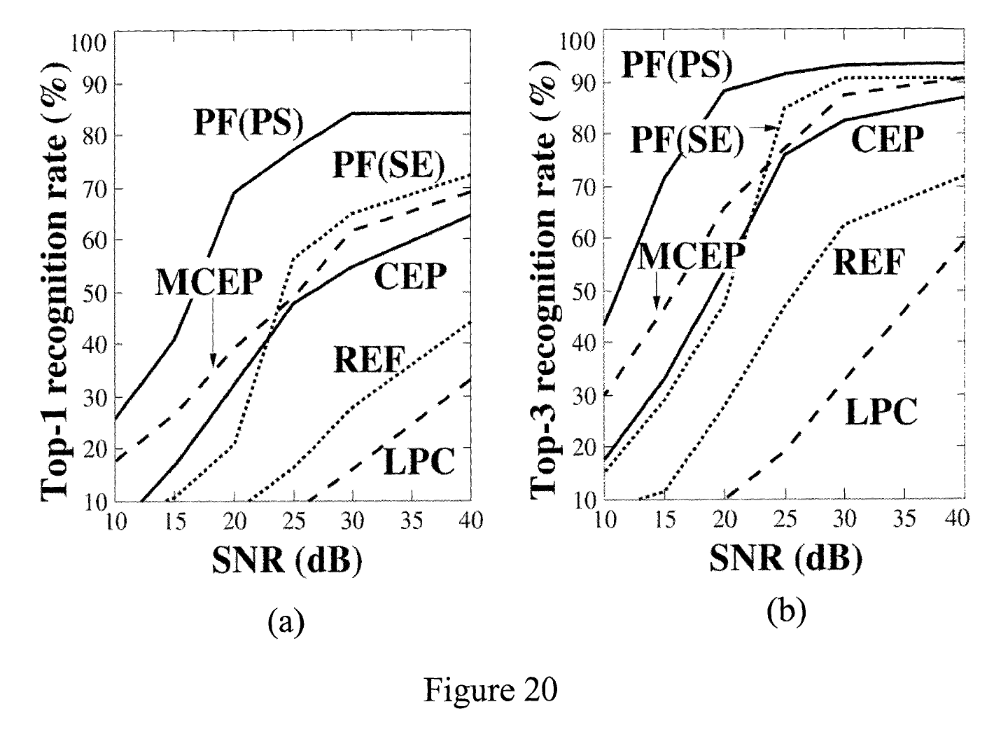

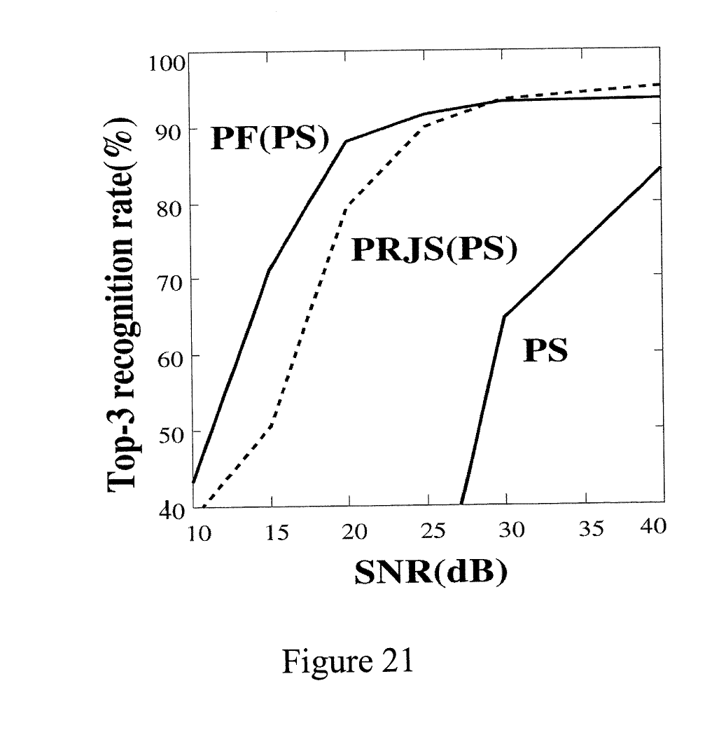

Due to the perceptual speech processor 112 and phonetic feature mapper 113 of the present invention, the phonetic feature 104 inputted to continuous HMM recognizer 114 is superior to those of conventional ASR systems, thereby producing more robust and accurate speech recognition. FIG. 20 is a graph of Recognition Rate versus SNR for an experiment adding white noise to input speech signals not in any training set. FIG. 20(a) shows the results for recognizing the top candidate to match the speech input and 20(b) is for the top three candidates (because of the many homonyms some speech must be further distinguished based on context). The upper left-hand side of the graph is the area of best speech recognition performance. The curve labeled PF(PS) represents the phonetic feature plus perceptual spectrum processing results (in other words, the present invention) and is farthest to the upper left. PF(SE) represents phonetic feature (FFT spectrum envelope) (i.e., speech processing with perceptual spectrum but without perceptual spectrum processing) and is next best. MCEP represents a conventional speech spectrum parameterization method known as mel-scale cepstral coefficients and is less immune to noise than the systems of the present invention. CEP represents cepstral coefficients alone, without mel-scale translation, and is more to the right of MCEP demonstrating the efficacy of the mel-scale. REF (reflection coefficients) and LPC (linear predictive coding) are other conventional speech recognition methods giving less desirable results. Thus it can be seen that the present invention achieves accuracy and robustness in speech recognition. FIG. 21 is a graph of the recognition rate versus SNR results of another experiment of three noisy speech tests using nine Mandarin vowels and projection similarity as inputs to continuous HMM 114, resulting in enhanced recognition accuracy. PF(PS) representing the present invention again produces the best results. PRJS(PS) represents projection similarity of the perceptual spectrum (i.e., the present invention without the phonetic feature processing), and PS is the perceptual spectrum alone (i.e., without the projection similarity calculations of the phonetic feature processing). The present invention not only achieves more robust and accurate speech recognition, but is also more computationally efficient than conventional methods since the speech spectrum parameterization is reduced from a typical 64 to 9. Phonetic feature mapping is also more immune to noise, partly because of its emphasis on the critical spectral components and ignoring the distortions caused by noise.

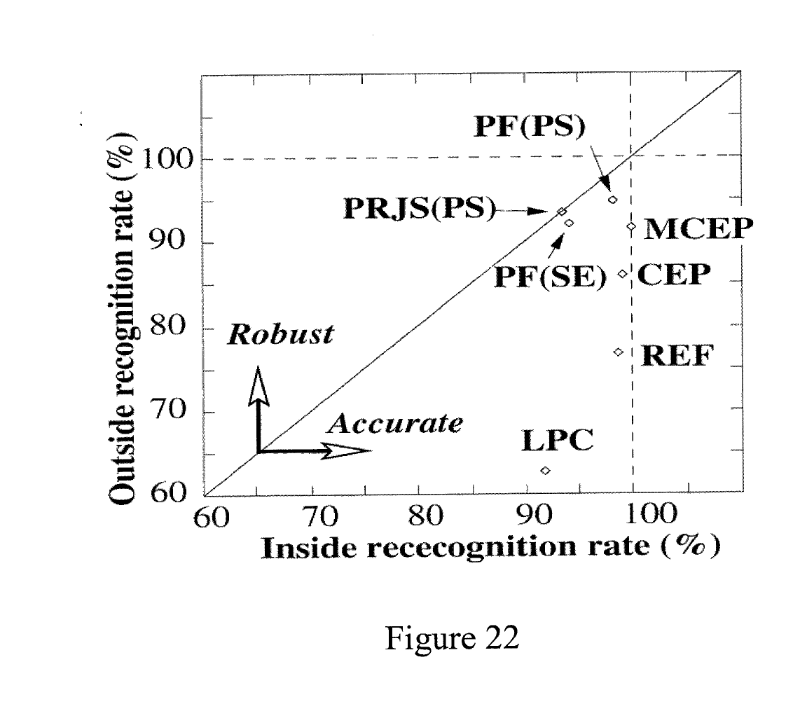

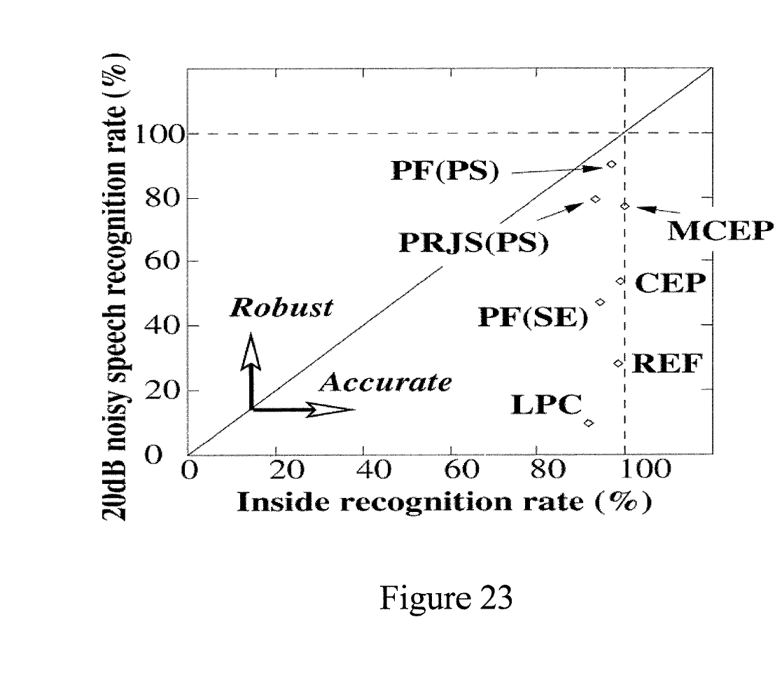

To demonstrate that the present invention effectively improves speech recognition, FIG. 22 is a graph of Outside Recognition Rate (%) (using different speakers) versus Inside Recognition Rate (%) (using a single speaker). Points towards the upper right-hand corner demonstrate the best robustness and accuracy. Again PF(PS) shows the best results compared to all the others. FIG. 23 is a graph of Noisy Speech Recognition Rate (%) (environmental noise) versus Inside Recognition Rate (%) (where there are more ideal listening conditions). Points towards the upper right-hand corner demonstrate the best robustness and accuracy. Once again PF(PS) shows the best results compared to other conventional speech recognition methods.

While the above is a full description of the specific embodiments, various modifications, alternative constructions and equivalents may be used. For example, although the examples shown were for Mandarin Chinese, the concepts described in the present invention are suitable for any language having syllables. Further, any implementation technique, either analog or digital, numerical or hardware processor, can be advantageously utilized. Therefore, the above description and illustrations should not be taken as limiting the scope of the present invention which is defined by the appended claims.

What is claimed is:

1. A speech processing system for processing an input speech spectrum vector comprising:
a perceptual speech processor for perceptually processing the input speech spectrum vector to generate a perceptual spectrum;
a storage device for storing a plurality of reference spectrum vectors; and
a phonetic feature mapper, coupled to said perceptual speech processor and to said storage device, for mapping said perceptual spectrum on to said plurality of reference spectrum vectors.

2. The speech processing system of claim 1 wherein said perceptual speech processor comprises:
a masking effector for noise masking the input speech spectrum vector to generate a masked input speech spectrum vector;
a minimum audible field curve renormalizer, coupled to said masking effector, for renormalizing said masked input speech spectrum vector responsive to a minimum audible field to generate a renormalized masked input speech spectrum vector; and
a mel-scale resampler, coupled to said minimum audible field renormalizer, for translating said renormalized masked input speech spectrum vector to mel-scale.

3. The speech processing system of claim 1 wherein said phonetic feature mapper comprises:
a projection similarity generator, coupled to said storage device, for generating a plurality of projection similarity calculations of the input spectrum vector onto said plurality of reference spectrum vectors;
a relative projection similarity generator; coupled to said storage device, for generating a plurality of relative projection similarity calculations of the input spectrum vector onto said plurality of reference spectrum vectors, and
a selector, coupled to said projection similarity generator and to said relative projection similarity generator, for selecting a projection similarity from between said projection similarity generator calculations and said relative projection similarity generator calculations responsive to the relative values of the projection similarity and relative projection similarity of the input speech spectrum vector on said plurality of reference spectrum vectors.

4. The speech processing system of claim 3 wherein said plurality of reference spectrum vectors is comprised of a plurality of stationary vowels.

5. The speech processing system of claim 4 wherein said plurality of stationary vowels is comprised of nine stationary Mandarin vowels.

6. A speech recognition system for recognizing a sampled speech spectrum vector comprising:
a fast Fourier transform analyzer for generating Fourier transforms of the sampled speech spectrum vector;
a perceptual speech processor, coupled to said fast Fourier transform analyzer, for processing said Fourier transforms to generate a perceptual spectrum;
a storage device for storing a plurality of reference spectrum vectors;
a phonetic feature mapper, coupled to said perceptual speech processor and to said storage device, for mapping said perceptual spectrum to said plurality of reference spectrum vectors, thereby selecting at least one reference vector of greatest similarity to said perceptual spectrum; and
a continuous HMM recognizer, coupled to said phonetic feature mapper, for recognizing said at least one reference vector.

7. The speech recognition system of claim 6 wherein said plurality of reference spectrum vectors is comprised of a plurality of stationary vowels.

8. The speech processing system of claim 7 wherein said plurality of stationary vowels is comprised of nine stationary Mandarin vowels.

9. A method for speech processing an input speech spectrum vector comprising the steps of:
preceptually processing the input speech spectrum vector to generate a perceptual spectrum;
storing a plurality of reference spectrum vectors; and
mapping said perceptual spectrum on to said plurality of reference spectrum vectors.

10. The speech processing method of claim 9 wherein said perceptually processing step further comprises the steps of:
noise masking the input speech spectrum vector to generate a masked input speech spectrum vector;
renormalizing said masked input speech spectrum vector responsive to a minimum audible field to generate a renormalized masked input speech spectrum vector; and
translating said renormalized masked input speech spectrum vector to mel-scale.

11. The speech processing method of claim 9 wherein said mapping step further comprises the steps of:
generating a plurality of projection similarity calculations of the input spectrum vector onto said plurality of reference spectrum vectors;
generating a plurality of relative projection similarity calculations of the input spectrum vector onto said plurality of reference spectrum vectors, and
selecting a projection similarity from between said projection similarity generator calculations and said relative projection similarity generator calculations responsive to the relative values of the projection similarity and relative projection similarity of the input speech spectrum vector on said plurality of reference spectrum vectors.

12. The speech processing method of claim 11 wherein said plurality of reference spectrum vectors is comprised of a plurality of stationary vowels.

13. The speech processing system of claim 12 wherein said plurality of stationary vowels is comprised of nine stationary Mandarin vowels.

14. A method for speech recognition of a sampled input speech spectrum vector, comprising the steps of:
generating Fourier transforms of the sampled input speech spectrum vector utilizing a fast Fourier transform analyzer;
generating a perceptual spectrum by processing said Fourier transforms;
storing a plurality of reference spectrum vectors;
mapping said perceptual spectrum onto said plurality of reference spectrum vectors;
selecting at least one reference vector of greatest similarity to said perceptual spectrum; and
recognizing said at least one reference vector utilizing a continuous HMM recognizer.

15. The speech recognition system of claim 14 wherein said plurality of reference spectrum vectors is comprised of a plurality of stationary vowels.

16. The speech processing system of claim 15 wherein said plurality of stationary vowels is comprised of nine stationary Mandarin vowels.
